(19) United States
(12) Patent Application Publication
(10) Pub. No.: US 2011/0187955 A1
(43) Pub. Date: Aug. 4, 2011

(54) DISPLAY DEVICE

(75) Inventor: Mei-sha Shih, Kaohsiung City (TW)

(73) Assignee: CHUNGHWA PICTURE TUBES, LTD., Bade City (TW)

(21) Appl. No.: 12/753,879

(22) Filed: Apr. 3, 2010

(30) Foreign Application Priority Data
Feb. 2, 2010 (TW) 099202135

(51) Int. Cl. G02F 1/1333; G02F 1/1343

(52) U.S. Cl. 349/54; 349/139

(57) ABSTRACT

A display device has a display panel that is divided into an active region for displaying images and a dummy region outside of the active region. The display device comprises a first substrate and a second substrate disposed in parallel and spaced apart from each other; a plurality of electrical conductive structures disposed on the first substrate and located within the dummy region; and a transparent conducting layer disposed on the second substrate and disposed over both the active region and the dummy region, the transparent conducting layer being utilized for providing a fixed voltage, wherein the transparent conducting layer in the dummy region has an empty area facing at least one electrical conductive structure. The empty area is formed by removing a conducting material of the transparent conducting layer. Parasitic capacitances in display device can be reduced.

### TECHNICAL FIELD OF THE INVENTION

The present invention relates to a display device, and more particularly, to a display device having a patterned transparent conductive layer.

### BACKGROUND OF THE INVENTION

Nowadays, how to reduce the manufacturing cost of a display device is an important topic. As gate-in-panel (GIP) technological skills have been matured, that a gate driver circuit is directly implemented on a display panel has become an efficient way to reduce the cost of the display device.

Please refer to FIG. 1, which is a diagram showing a cross-sectional view of a conventional liquid crystal display (LCD) device utilizing the gate-in-panel technique. As shown in FIG. 1, the conventional LCD device includes a thin-film transistor (TFT) array substrate 110, a color filter (CF) substrate 120, and a liquid crystal layer 130. The two substrates 110, 120 are facing each other, and the liquid crystal layer 130 is disposed therebetween. A transparent conducting layer 125 is disposed on the side of the CF substrate 120 facing the TFT array substrate 110. The transparent conducting layer 125 serves as a common electrode of the display panel for providing a fixed voltage. In addition, a gate driver circuit 112 is disposed in a non-display region of the display panel. Particularly, the gate driver circuit 112 is disposed on the side of TFT array substrate 110 facing the CF substrate 120. However, the gate driver circuit 112 would be interfered by the transparent conducting layer 125 disposed on the opposite side of the CF substrate 120 since parasitic capacitances are generated between the gate driver circuit 112 and the transparent conducting layer 125. The parasitic capacitances may affect the stability of displaying images. It is noted that the non-display region of the display panel may include a part of the liquid crystal layer 130 as shown in FIG. 1.

Generally, a sealing material is utilized for adhering to a periphery of the display panel and is adhered between the TFT array substrate 110 and the CF substrate 120 for sealing the gap therebetween. In order to reduce the parasitic capacitances generated between the gate driver circuit 112 of the TFT array substrate 110 and the opposite transparent conducting layer 125, the gate driver circuit 112 is implemented on a seal region 145 in the conventional LCD device. However, the material of the seal 145 must be selected appropriately for avoiding electrical connection between the gate driver circuit 112 and the seal 145. Therefore, available types of materials for the seal 145 are reduced, and the selection of materials for the seal 145 is limited. Moreover, the position of the gate driver circuit 112 must be arranged in accordance with the seal region 145, and this further limits the design of the display panel.

### SUMMARY OF THE INVENTION

An objective of the present invention is to provide a display device of which parasitic capacitances can be reduced.

Another objective of the present invention is to provide a display device of which the stability of displaying images is increased.

According to the above objectives, the present invention provides a display device including a display panel that is divided into an active region for displaying images and a dummy region outside of the active region. The display device comprises a first substrate and a second substrate disposed in parallel and spaced apart from each other; a plurality of electrical conductive structures disposed on the first substrate and located within the dummy region; and a transparent conducting layer disposed on the second substrate and disposed over both the active region and the dummy region, the transparent conducting layer being utilized for providing a fixed voltage, wherein the transparent conducting layer in the dummy region has an empty area facing at least one electrical conductive structure. The empty area is formed by removing a conducting material of the transparent conducting layer.

In the embodiments of the present invention, the afore-mentioned electrical conductive structure may comprise a gate driver circuit, a source driver circuit, a repair line, a signal line and the like on a TFT array substrate. The electrical conductive structure may also comprise gate wires for connecting scan lines to the gate driver circuit, and source wires for connecting data lines to the source driver circuit.

In the present invention, the conducting material located above an electrical conductive structure that is disposed on the side of a TFT array substrate facing a CF substrate is removed, and an empty area is thereby formed in the dummy region. The electrical conductive structure has no conducting material residing above, and thus parasitic capacitances are reduced. Moreover, the transmission of electronic signals on the electrical conductive structure becomes more stable, and thereby increasing the stability of displaying images.

### BRIEF DESCRIPTION OF THE DRAWINGS

The present invention will be described in details in conjunction with the appending drawings.

FIG. 1 is a diagram showing a cross-sectional view of a conventional liquid crystal display device utilizing a gate-in-panel technique.

FIG. 2 is a diagram showing a layout of a liquid crystal display (LCD) device.

FIG. 3A is a diagram showing a cross-sectional view of the liquid crystal display device in which an empty area of a transparent conducting layer is formed above a gate driver circuit according to a first embodiment of the present invention.

FIG. 3B is a diagram showing a cross-sectional view of the liquid crystal display device in which an empty area of the transparent conducting layer is formed above a source driver circuit according to the first embodiment of the present invention.

FIG. 4A is a diagram showing a cross-sectional view of the liquid crystal display device in which an empty area of a transparent conducting layer is formed above a repair line according to a second embodiment of the present invention.

FIG. 4B is a diagram showing a cross-sectional view of the liquid crystal display device in which an empty area of the transparent conducting layer is formed above the repair line and signal lines according to the second embodiment of the present invention.

FIG. 4C is a diagram showing a cross-sectional view of the liquid crystal display device in which an empty area of the transparent conducting layer is formed above the repair line and is formed at a periphery of the transparent conducting layer according to the second embodiment of the present invention.

FIG. 5A is a diagram showing a cross-sectional view of the liquid crystal display device in which an empty area of a transparent conducting layer is formed above gate wires (or source wires) according to a third embodiment of the present invention.

FIG. 5B is a diagram showing a cross-sectional view of the liquid crystal display device in which an empty area of the transparent conducting layer is formed above gate wires (or source wires) and is formed above the regions between two sections of gate wires (or two sections of source wires) according to the third embodiment of the present invention.

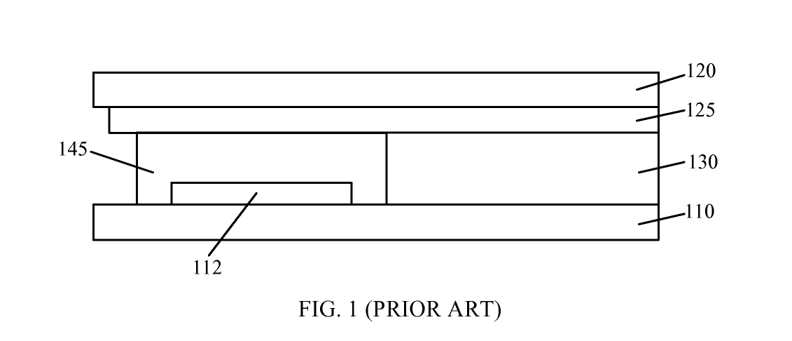

### DETAILED DESCRIPTION OF THE INVENTION

In order to make the present invention to be more easily understood, embodiments for carrying out the present invention will be described in details in conjunction with the appending drawings. In the specification, the elements that have similar functions or similar structures are labeled with the same reference numbers.

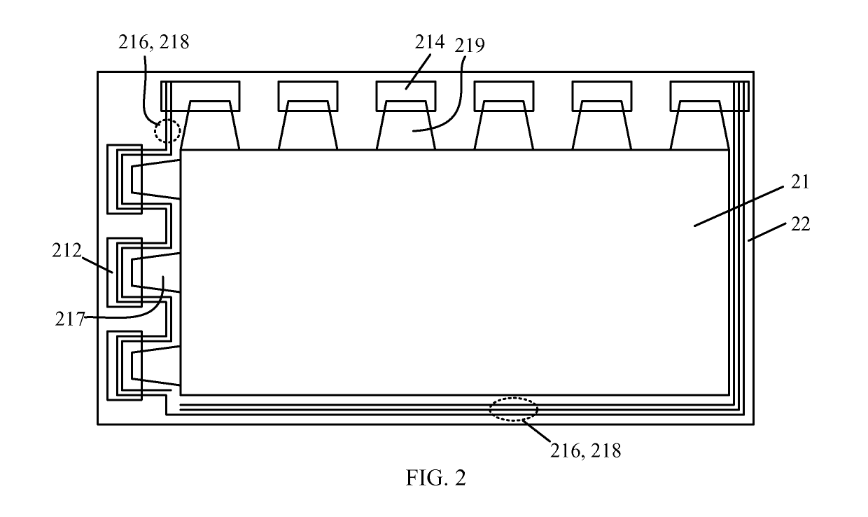

Please refer to FIG. 2, which is a diagram showing a layout of a liquid crystal display (LCD) device. As shown in FIG. 2, a display panel is divided into an active region 21 and a dummy region 22. The active region 21, also called a display region, is an area for displaying images. In the active region 21, there are a plurality of scan lines (not shown) and a plurality of data lines (not shown) interlaced with one another. Each crossing point has a thin-film transistor (TFT) (not shown) disposed nearby. The thin-film transistor is utilized for receiving a pixel data and controlling the pixel data to be updated.

As shown in FIG. 2, driving circuits and wiring lines are disposed in the dummy region 22. The dummy region 22 is a non-display region. Images are not displayed in the dummy region 22. The scan lines and data lines of the active region 21 are respectively connected to gate driver circuits 212 and source driver circuits 214 in the dummy region 22. During routing, gate wires 217 are utilized for connecting the scan lines to the gate driver circuits 212, and source wires 219 are utilized for connecting the data lines to the source driver circuits 214. In addition, there are repair lines 216 and signal lines 218 in the dummy region 22. The signal lines 218 are capable of transmitting signals between electronic components. The repair lines 216 are utilized for repairing poor connections, e.g. a poor connection of a scan line or a gate line on the display panel.

It is noted that the gate driver circuits 212, source driver circuits 214, gate wires 217, source wires 219, repair lines 216, and signal lines 218 shown in FIG. 2 are varied in design or arrangement for different types of display panels. The layout shown in FIG. 2 is only for illustration purposes.

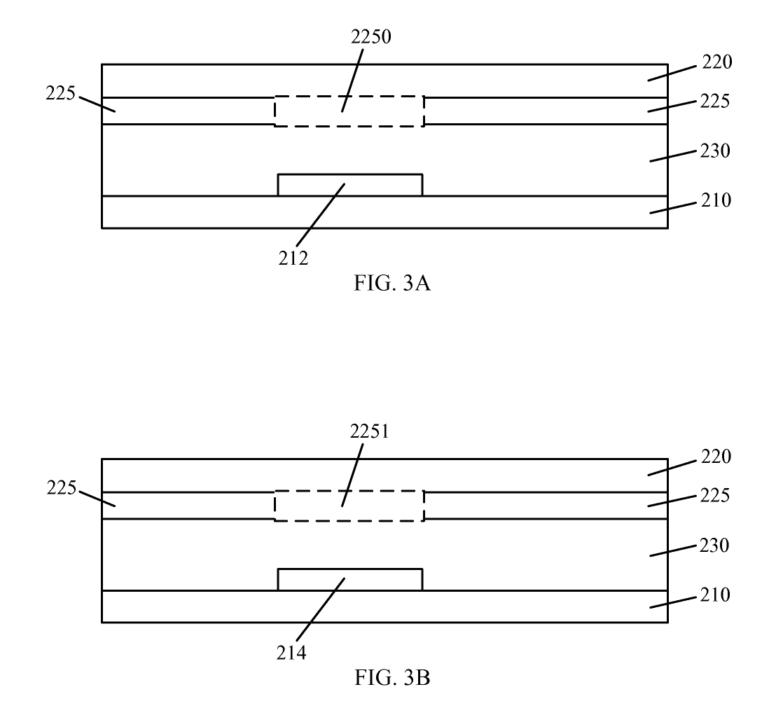

FIG. 3A and FIG. 3B are diagrams showing cross-sectional views of liquid crystal display devices implemented according to a first embodiment of the present invention. It is noted that FIG. 3A and FIG. 3B only show the structures respectively corresponding to the gate driver circuit 212 and source driver circuit 214 of the dummy region 22 in FIG. 2 instead of showing the whole structures of the LCD devices. As shown in FIG. 3A and FIG. 3B, the LCD device includes a thin-film transistor (TFT) array substrate 210, a color filter (CF) substrate 220, and a liquid crystal layer 230. The two substrates 210, 220 are facing each other, and the liquid crystal layer 230 is disposed therebetween. A transparent conducting layer 225 is disposed on the side of the CF substrate 220 facing the TFT array substrate 210. The transparent conducting layer 225 is disposed over both the active region 21 and the dummy region 22, and serves as a common electrode of the display panel for providing a fixed voltage. The transparent conducting layer 225 may generally be implemented by an indium tin oxide (ITO) film.

As shown in FIG. 2 and FIG. 3A, the gate driver circuit 212 of the dummy region 22 is disposed on the side of the TFT array substrate 210 facing the CF substrate 220. The gate driver circuit 212 is facing or opposite to an empty area 2250 of the transparent conducting layer 225. The empty area 2250 is formed by removing a conducting material of the transparent conducting layer 225. In the present invention, the empty area 2250 may be formed by patterning the transparent conducting layer 225. In another aspect, an empty area 2251 of the transparent conducting layer 225 may also be formed above the position where the source driver circuit 214 is located, as shown in FIG. 2 and FIG. 3B.

In the present invention, the conducting material located above an electrical conductive structure (i.e. the gate driver circuit 212 or the source driver circuit 214) that is disposed on the side of the TFT array substrate 210 facing the CF substrate 220 is removed, and the empty area (2250 or 2251) is thereby formed in the dummy region 22. The electrical conductive structure has no conducting material residing above, and thus parasitic capacitances are reduced. Moreover, the transmission of electronic signals on the electrical conductive structure becomes more stable, and thereby the stability of displaying images is increased.

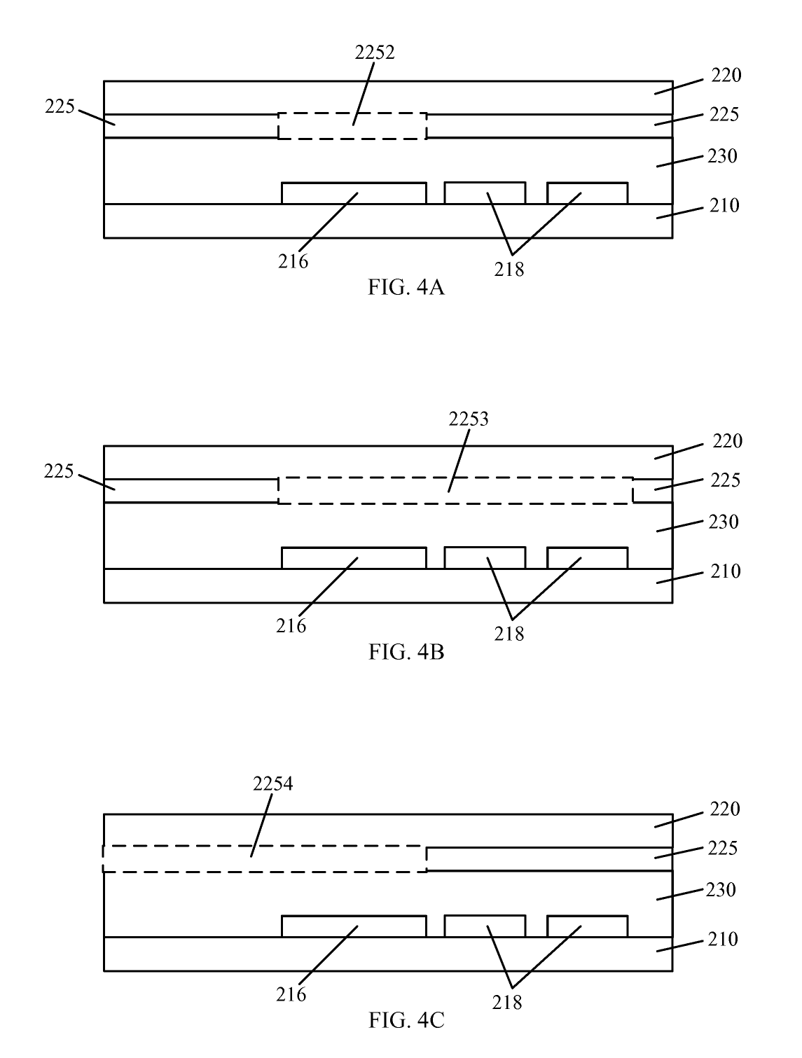

FIG. 4A, FIG. 4B and FIG. 4C are diagrams showing cross-sectional views of liquid crystal display devices implemented according to a second embodiment of the present invention. It is noted that FIG. 4A, FIG. 4B and FIG. 4C only show the structures corresponding to the repair line 216 and signal lines 218 of the dummy region 22 in FIG. 2, instead of showing the whole structures of the LCD devices.

As shown in FIG. 2 and FIG. 4A, the repair line 216 of the dummy region 22 is disposed on the side of the TFT array substrate 210 facing the CF substrate 220. The repair line 216 is facing or opposite to an empty area 2252 of the transparent conducting layer 225. The empty area 2252 is formed by removing a conducting material of the transparent conducting layer 225. Since the conducting material located above the repair line 216 is removed, the repair line 216 has no conducting material residing above, and parasitic capacitances are thereby reduced.

In another aspect, the conducting material of the transparent conducting material 225 located above signal lines 218 may also be removed, and an empty area 2253 is thereby formed as shown in FIG. 4B. Therefore, electrical conductive structures (the repair line 216 and signal lines 218) have no conducting material residing above.

In still another aspect, the repair line 216 is disposed at a periphery of the dummy region 22 of the display panel. Under this arrangement, the conducting material at a periphery of the transparent conducting material 225 may also be removed instead of only removing the conducting material located above the repair line 216. As shown in FIG. 4C, an empty area 2254 which is stretched to an edge of the transparent conducting layer 225 is formed. Off course, this implementation may also be suitable for an electrical conductive structure disposed at a periphery of the dummy region 22, not merely for the repair line 216.

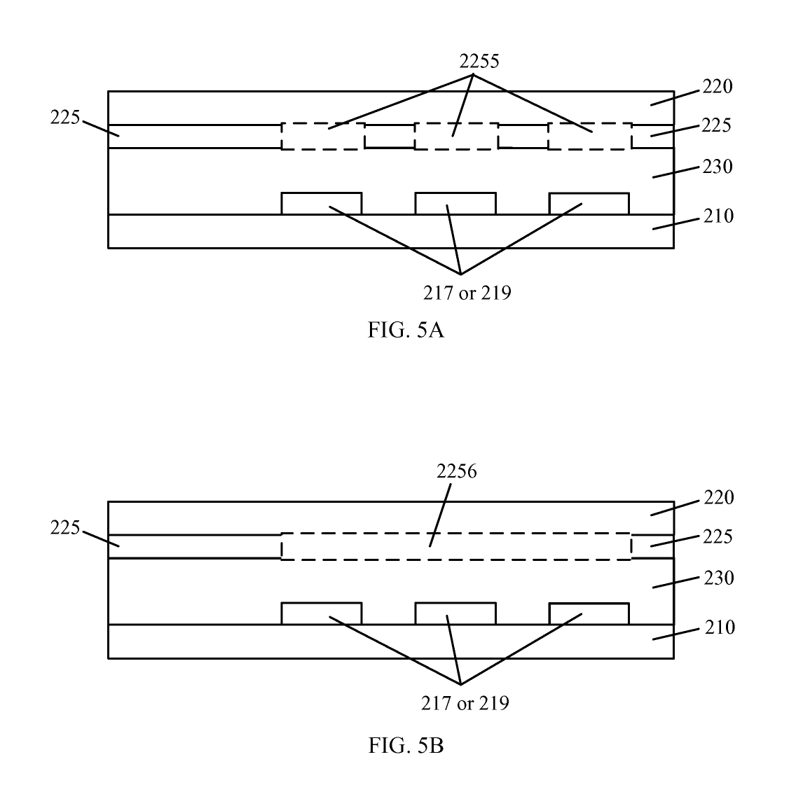

FIG. 5A and FIG. 5B are diagrams showing cross-sectional views of liquid crystal display devices implemented according to a third embodiment of the present invention. It is noted that FIG. 5A and FIG. 5B only show the structures corresponding to the gate wires 217 or source wires 219 of the dummy region 22 in FIG. 2 instead of showing the whole structures of the LCD devices.

As shown in FIG. 2 and FIG. 5A, the gate wires 217 which is utilized for connecting the scan lines (not shown) to the gate driver circuit 212 and the source wires 219 which is utilized for connecting the data lines (not shown) to the source driver circuit 214 are disposed on the side of the TFT array substrate 210 facing the CF substrate 220. The gate wires 217 (or the source wires 219) are facing or opposite to an empty area 2255 of the transparent conducting layer 225. The empty area 2255 is formed by removing a conducting material of the transparent conducting layer 225. Since the conducting material located above the gate wires 217 (or the source wires 219) is removed, the gate wires 217 (or the source wires 219) have no conducting material residing above, and parasitic capacitances are thereby reduced.

In another aspect, the conducting material that is residing between the regions located right above two sections of gate wires 217 (or two sections of source wires 219) may also be removed, and an empty area 2256 is thereby formed as shown in FIG. 5B. Electrical conductive structures (the gate wires 217 and/or the source wires 219) have no conducting material residing above as shown in FIG. 5A and FIG. 5B, and parasitic capacitances are thereby reduced.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A display device, including a display panel that is divided into an active region for displaying images and a dummy region outside of the active region, the display device comprising:
a first substrate and a second substrate disposed in parallel and spaced apart from each other;
a plurality of electrical conductive structures disposed on the first substrate and located within the dummy region; and
a transparent conducting layer disposed on the second substrate and disposed over both the active region and the dummy region, the transparent conducting layer being utilized for providing a fixed voltage, wherein the transparent conducting layer in the dummy region has an empty area facing at least one electrical conductive structure, and the empty area is formed by removing a conducting material of the transparent conducting layer.

2. The display device of claim 1, wherein said at least one electrical conductive structure comprises a gate driver circuit.

3. The display device of claim 1, wherein said at least one electrical conductive structure comprises a source driver circuit.

4. The display device of claim 1, wherein said at least one electrical conductive structure comprises a repair line.

5. The display device of claim 4, wherein said repair line is utilized for repairing a poor connection of a scan line on the display panel.

6. The display device of claim 4, wherein said repair line is utilized for repairing a poor connection of a data line on the display panel.

7. The display device of claim 4, wherein said repair line is disposed at a periphery of the dummy region.

8. The display device of claim 1, wherein said at least one electrical conductive structure comprises a plurality of wires, and each wire is utilized for connecting a scan line of the display panel to a gate driver circuit.

9. The display device of claim 1, wherein said at least one electrical conductive structure comprises a plurality of wires, and each wire is utilized for connecting a data line of the display panel to a source driver circuit.

10. The display device of claim 1, wherein the empty area is stretched to an edge of the transparent conducting layer.

11. The display device of claim 1, further comprising a liquid crystal layer disposed between the first substrate and the second substrate.

12. The display device of claim 1, wherein the transparent conducting layer is an indium tin oxide (ITO) film.
